(19) United States
(12) Patent Application Publication
(10) Pub. No.: US 2024/0393430 A1
(43) Pub. Date: Nov. 28, 2024

(54) METHOD, SYSTEM AND USE FOR RADAR-BASED MEASUREMENT

(71) Applicants: 2pi-Labs GmbH, Bochum (DE); RUHR-UNIVERSITÄT BOCHUM, Bochum (DE)

(72) Inventors: Timo JAESCHKE, Hattingen (DE); Simon KUEPPERS, Bochum (DE); Jan BAROWSKI, Bochum (DE)

(21) Appl. No.: 18/688,597

(22) PCT Filed: Sep. 2, 2022
(86) PCT No.: PCT/EP2022/074478

§ 371 Date: Mar. 1, 2024

(30) Foreign Application Priority Data
Sep. 3, 2021 (EP) 21194897.1
Sep. 20, 2021 (EP) 21197756.6

(51) Int. Cl. G01S 7/40; G01S 7/02; G01S 7/35; G01S 7/41; G01S 13/34

(52) U.S. Cl. CPC G01S 7/4021; G01S 7/024; G01S 7/356; G01S 7/4008; G01S 7/417; G01S 13/343

(57) ABSTRACT

The present invention relates to a method for radar-based measurement comprising an emission of a—preferably FMCW or pulse-based—radar transmission signal into a measuring zone of a measuring setup in which the measurement object can be arranged or is arranged, and detecting both at least one component of the radar transmission signal reflected by the measurement object and at least one component of the radar transmission signal transmitted by the measurement object independently of one another as radar received signals, from which a measurement result representing the radar received signals is formed.

In particular, the present invention relates to the radar-based measurement of a measurement object that can be arranged or is arranged in a measuring zone of a measurement setup using a radar transmission signal.

The radar transmission signal is preferably an FMCW radar transmission signal. Alternatively or additionally, it can be a pulse-based radar transmission signal. It is preferably a wideband radar transmission signal, for example with a bandwidth of more than 5% or 10% of the center frequency. The radar transmission signal can be emitted into the measuring zone for the purpose of measurement. Preferably, however, the radar transmission signal does not have any THz pulses.

DE 10 2017 125 740 B4 relates to a THz measuring device for measuring at least one layer thickness of a test specimen conveyed along a conveying direction. Here, the measurement is performed using electromagnetic waves of a frequency that is also used in radar systems and for characterizing a test specimen, which represents a measurement object, in a measuring device, which represents a measurement setup. However, the system is not a radar-based system, as the signals used are not radar signals, in particular not FMCW or pulse radar signals.

DE 10 2016 105 599 A1 relates to a THz measuring device and a THz measuring method, whereby defects in the test object can be specifically detected by measuring reflected THz radiation. This is also not a radar-based system, as the signals used are not radar signals, in particular not FMCW or pulse radar signals. Furthermore, there is no correction of the measurement result to compensate for components that are due to the measurement setup and/or insignificant parts of the measuring zone and/or measurement object and/or variations over the frequency and/or to analyze separately with frequency and/or time resolution.

On the one hand, measuring systems are known in the state of the art that work with radar signals, but are regularly limited to the evaluation of reflected signal components, in particular for distance detection and/or determination of a relative speed. Separate from this are systems in which THz radiation is used for material characterization, whereby the THz radiation is not regularly present in the form of radar signals.

DE 10 2019 008 595 A1 uses an FMCW radar method to determine the thickness and/or dielectric constant of an object. For this purpose, chirp signals are emitted by means of a transmitter-receiver, which are transmitted twice through the object by means of a reflector. Only the transmitted signals are used in the evaluation. Although a phase can also be taken into account in the evaluation, this is a phase formed and/or averaged over the entire frequency range. A frequency-dependent phase evaluation does not take place. Furthermore, there is no correction of the measurement result to compensate for components that are attributable to the measurement setup and/or insignificant parts of the measuring zone and/or measurement object and/or variations over the frequency and/or to analyze separately with frequency and/or time resolution.

WO 2020/078866 A1 uses FMCW waves to detect flaws in the insulation of a cooling unit, whereby a doubly transmitted signal is evaluated. Reflected radiation is only used to determine the distance between the measurement object and the transceiver, but not for detecting the defects. Furthermore, there is no correction of the measurement result to compensate for components that are due to the measurement setup and/or insignificant parts of the measuring zone and/or measurement object and/or variations over the frequency and/or to analyze separately with frequency and/or time resolution.

The task of the present invention is to provide a method for measurement as well as a system for carrying out the method and a use in which the measurement of a measurement object which can be arranged or is arranged in a measuring zone of a measurement setup with high-frequency electromagnetic radiation can be improved.

The invention is solved by a method according to claim 1, a system according to claim 14 or a use according to claim 15. Advantageous further embodiments of the invention are the subject of the subclaims.

According to a first, independently realizable aspect of the present invention, a radar transmission signal—preferably FMCW or pulse-based radar transmission signal—is emitted into a measuring zone of a measuring setup in which a measurement object can be arranged or is arranged.

In addition, both, at least one, component of the radar transmission signal reflected by the measurement object and at least one component of the radar transmission signal transmitted by the measurement object are detected independently of one another as radar received signals, from which a measurement result representing the radar received signals is or is formed.

First of all, a major difference to the known systems is that a radar signal is used.

In the sense of the present invention, radar signals are particularly preferably so-called FMCW signals, i.e. signals which have one or more frequency ramps and/or have an at least essentially continuous or linear frequency change over time. Alternatively or additionally, radar signals may have pulses as used in pulse radar systems. In both cases, the radar signals are basically suitable for enabling radio-based detection, distance and/or (relative) speed determination.

Radar signals within the meaning of the present invention are further particularly preferred high-frequency signals and/or signals with frequencies greater than 50 GHz and/or less than 1 THz.

Furthermore, radar signals in the sense of the present invention are particularly preferably wideband signals, i.e. they contain in particular frequency components in a frequency range which, in relation to a center frequency, has a bandwidth of more than 5%, preferably more than 10%, in particular more than 15%, of the center frequency.

In particular, a radar signal within the meaning of the present invention thus has one or more frequency ramps which, in relation to their center frequency, which is preferably above 50 GHz and/or below 1 THz, sweep over frequencies which, in relation to a center frequency, result in a bandwidth of more than 5%, 10% or 15%.

In the method and/or system according to the proposal, the measurement is preferably coherent. For this purpose, transmit and receive signals are preferably converted with mutually coherent (in particular local oscillator-stabilized) signals. Coherent signals are signals that have the same frequency and phases with a known phase relationship to each other—in particular the same phase. This means that both amplitude and phase measurement values can be detected (for a radar target) as a function of frequency and/or time. The proposed system is preferably homodyne and/or the transmitter and receiver are operated homodyne. In contrast to approaches that can only determine amplitude information, the advantageous (supplementary) detection of the phase relationship and/or phase measurement values is of particular value due to the significantly improved measurement accuracy.

In radar technology, it is common practice to receive and evaluate only the reflected components of a radar transmission signal. This applies in particular to all classic radar applications such as in the automotive or air traffic control sector, but also in the field of industrial measurement technology. The present invention takes a new approach here, in that both reflected components and transmitted components of an emitted radar transmission signal are detected, i.e. received and converted into a measurement result.

The components measured independently of each other contain (linearly) independent information. This can enable the particularly advantageous measures explained below, in particular a correction of the measurement result, for example by eliminating components of the measurement result that are foreign to the measurement object, and/or the particularly accurate determination or modeling of properties of the measurement object, and/or the determination of a transfer function and/or one or more physical parameters of the measurement object.

A measurement result in the sense of the present invention represents the radar received signals, i.e. the reflected and transmitted components of the radar transmission signal. A measurement object in the sense of the present invention is preferably an object and most preferably a product in the manufacturing process. The measurement object is preferably positionable and/or producible by a positioning and/or production facility. Very preferably, the measurement object is a product that can preferably be produced in a continuous process and/or is in the process of being produced, for example a strand such as a tube or other extrusion and/or extruded product. However, the measurement object can also be another product that can preferably be produced with an industrial production plant, a semi-finished product, a fluid, a fluidizable solid (dust), a liquid, a paste or the like.

The measurement result can have or be formed by the reflected and transmitted components of the radar transmission signal and/or parameters representing these. Alternatively or additionally, however, the measurement result can also be derived from these and represent the radar received signals directly or indirectly. This can be done particularly preferably by forming two-port parameters and/or a matrix comprising the two-port parameters as a measurement result on the basis of the radar received signals.

In particular, two-port parameters are scattering parameters, transmission parameters and/or chain parameters. The two-port parameters preferably contain information on wave transmission and/or wave reflection of the radar transmission signal to the measurement object and/or in the measuring zone.

Preferred in this context are scattering parameters (S-parameters), transmission parameters (Z-parameters) and/or chain parameters (ABCD-parameters). These can be understood as elements of a vector or a matrix and/or be or have complex and/or frequency-dependent values, i.e. parameters with real and imaginary parts. The measurement result can therefore be represented as a vector or matrix based on the two-port parameters, in particular as a scatter matrix, transmission matrix and/or chain matrix.

Alternatively, additionally or following a representation of the measurement result with second-port parameters, a, preferably complex, transfer function can be determined as a measurement result on the basis of the radar received signals or second-port parameters.

The radar received signals and the corresponding measurement result preferably contain (according to the characteristics and/or the bandwidth of the radar transmission signal) components of different frequencies and/or a time characteristic that corresponds to a frequency characteristic, in particular that can be proportional to it. The latter is the case in particular with FMCW radar transmission signals due to the frequency ramps they contain. In this case, the radar transmission signal is a signal that varies in frequency over time and the same applies to the radar reception signals and the measurement result representing them, which preferably has a frequency dependence.

A time dependence, on the other hand, does not necessarily have to be directly represented by the measurement result if the measurement result is frequency-dependent, or conversely, the frequency dependence does not necessarily have to be directly represented if a time dependence is taken into account, since the frequency dependence and the time dependence correspond to each other in many cases and in particular in the case of FMCW signals due to the linear frequency ramps. It is therefore preferably sufficient if either a time dependence or a frequency dependence of the components or radar received signals are represented in the measurement result. However, the measurement result preferably has at least either a time dependence or a frequency dependence.

The reflected component of the radar transmission signal is preferably a portion of the radar transmission signal that is reflected by the measurement object. There are different transmission options for the transmitted component of the radar transmission signal.

On the one hand, the transmitted component can be a component of the radar transmission signal that is transmitted once (completely) through the measuring zone and/or the measurement object, i.e. it is received on the side of the measuring zone and/or measurement object facing away from the radar emitter arrangement and/or its antenna.

Alternatively or additionally, the transmitted component can be a double-transmitted component, which can be generated by reflecting the component of the radar transmission signal (completely) transmitted through the measuring zone and/or the measuring object on the side of the measuring object or its antenna facing away from the radar emitter arrangement or its antenna by means of a reflector and passing the measuring object and/or the measuring zone again in order to reach the radar detector arrangement and/or its antenna.

A measurement object irradiated with the radar transmission signal generally both reflects and simultaneously transmits components of the radar transmission signal. It is intended that the reflected and transmitted components are detected independently of each other, preferably spatially or temporally separated from each other, and/or are represented in the measurement result. Preferably, this includes the possibility that the reflected and transmitted components are present in a combination, but (mathematically) separable from each other.

Alternatively or additionally, several radar receivers can be arranged and/or aligned at different angles to the measuring zone and/or measurement object. In particular, this can be provided so that the reflected and transmitted components of the radar transmission signal can be measured or extracted with the different radar receivers. Several radar receivers can therefore be positioned mirror-inverted and/or diametrically opposite each other in relation to the measuring zone, but alternatively or additionally they can also be directed towards the measuring zone in a different way and/or detect reflected and/or transmitted components of the radar transmission signal from other, different directions.

In the case of detection of the single-transmitted component, this is at least essentially independent of the reflected component. In the case of double-transmission, two different measurements with different boundary conditions can preferably be carried out with the same radar detector arrangement, the same radar receiver and/or the same radar antenna, for example with an active reflector for detecting the (double-transmitted) component and a deactivated reflector for detecting the reflected component.

When detecting the double-transmitted component of the radar transmission signal, it may have to be taken into account that the still reflected component of the radar transmission signal may also be superimposed during detection. For the purposes of the present invention, it is preferred that a double-transmitted component with a superimposed reflected component of the radar transmission signal is also considered to be a transmitted component. This is because it is possible to separate the components from one another by subtracting, for example, a previously detected reflected component from the transmitted component with a superimposed reflected component or by taking the correlations into account when determining the measurement result.

Furthermore, the radar detector arrangement can either be designed to detect the different components at different positions, for example using different antennas and/or receivers, or the radar detector arrangement is supplemented by a reflector on a side of the measuring zone facing away from the antennas of the radar detector arrangement, so that the radar detector arrangement can detect the double-transmitted component as a transmitted component of the radar transmission signal, which has therefore passed through the measurement object or the measuring zone twice, preferably in opposite directions.

Preferably, a reflection measurement is performed to detect the reflected component and a transmission measurement is performed to detect the transmitted component.

A reflection measurement in the sense of the present invention is preferably a detection of components of the radar transmission signal reflected at the measurement object and/or in the measuring zone. In this case, the reflection occurs at the measurement object and/or at boundary surfaces of the measurement object. It can also be reflections at different locations, which may overlap. In this context, it is possible that the reflection measurement has parts of the radar transmission signal that have initially partially entered the measurement object, have been reflected within the measurement object and form a part of the reflected component of the radar transmission signal due to back transmission. Preferably, the reflected component represents conclusions about components reflected at different locations by its frequency bandwidth.

A transmission measurement in the sense of the present invention is first of all the detection of that component of the radar transmission signal which preferably passes completely through the measurement object at least once. Superimposed, multiple-reflected components of the radar transmission signal cannot be excluded here. Furthermore, the detection of a double transmission, i.e. the double crossing of the measurement object with the radar transmission signal in preferably opposite directions, is also preferably considered a transmission measurement.

The variants (1) of the detection of the component that simply crosses the measuring zone or the measurement object completely (single transmission) and (2) of the detection of the component that crosses the measuring zone or the measurement object several times (double transmission), i.e. the variants (1) with two radar receivers on different sides of the measuring zone or measurement object and (2) with a reflector can also be realized separately and independently of each other and can represent individual invention complexes. Here, variant (1) can have advantages due to improved independence of the components and/or variant (2) due to less effort and/or use of materials.

The variants can also be combined so that both the single-transmitted and double-transmitted components are/can be detected and/or represented by the measurement result.

The components preferably each have at least information on magnitude and phase.

A measurement setup according to the present invention is designed to emit the radar transmission signal into the measuring zone and to detect both reflected and transmitted components of the radar transmission signal (separately from each other). Accordingly, the measurement setup has at least one radar emitter arrangement for generating and emitting the radar transmission signal into the measuring zone and at least one radar detector arrangement which is designed to receive both at least one component reflected by the measurement object or in the measuring zone and at least one component of the radar transmission signal which is transmitted (completely) at least once through the measurement object and/or through the measuring zone.

A measuring zone in the sense of the present invention is a zone into which the radar transmission signal is emitted or can be emitted and in which the measurement object is arranged or can be arranged, preferably movable or moved. The measuring zone preferably extends between an antenna interface of the radar emitter arrangement and either an antenna interface of the radar detector arrangement or the reflector in the case of double transmission.

In a particularly advantageous further development of the present invention, the measurement result is corrected, whereby a corrected measurement result is determined by compensating for components of the measurement result that are attributable to the measurement setup without the measuring zone.

The fact that the measurement result represents both components reflected by the measurement object and components transmitted through the measurement object has surprisingly shown that the independence of these components allows compensation of the components of the measurement result that are attributable to the measurement setup, even in the case of radar signals.

A calibration value is particularly preferred for correcting the measurement result, in particular for compensating for the components of the measurement result that are attributable to the measurement setup without the measuring zone and/or the measurement object. The measurement result is processed with the calibration value in order to (at least partially) compensate for the components of the measurement result that are caused by the measurement setup outside the measuring zone. In particular, this can be done by a mathematical operation. For this purpose, the calibration value can be or have a vector or a matrix, which, calculated with the measurement result, in particular multiplied, leads to the corrected measurement result.

A calibration value in the sense of the present invention is preferably a measurement result representing the measurement setup without the measuring zone and/or the measurement object. Accordingly, the calibration value, like the measurement result, can in particular be in the form of a (complex) transfer function and/or two-port parameters. In the case of a calibration value in the form of two-port parameters, it is possible to understand the calibration value as a so-called error two-port and to adjust the measurement result by the calibration value and/or the error two-port using corresponding vector or matrix-based arithmetic operations, which can ultimately lead to compensation of the components of the measurement result that are caused by the measurement setup outside the measuring zone and/or outside the measurement object.

The representation of the measurement result as a matrix of two-port parameters is particularly advantageous in this context, as established mathematical methods are known for this purpose to effect and/or calculate the compensation by means of a mathematical operation. In particular, both the measurement result and the calibration value are represented by a matrix of two-port parameters, so that the correction can be performed with a calculation based on the matrices. It is particularly preferred that the calibration value has parameters that describe at least one error two-port that represents the behavior of the measurement setup.

The components of the radar received signals and/or the measurement result attributable to the measurement setup are preferably components on the transmitting side which are attributable to the radar emitter arrangement comprising a radar antenna, a feed line to the radar antenna and a radar signal generator, and/or components on the receiving side which are attributable to a radar detector arrangement comprising an antenna, a feed line and a radar receiver and, if applicable, a filter contained therein.

With regard to the two-port parameters, scattering parameters and transmission parameters and/or scattering matrices and transmission matrices and/or so-called chain matrix parameters and/or chain matrices or ABCD parameters and/or ABCD matrices can be used for this purpose.

It is therefore preferred that at least one parameter set representing the error two-port is determined as the calibration value, which represents the influences of the measurement setup without the measuring zone or the measurement object. The error two-port parameter(s) can in turn be represented by two-port parameters, for example in matrix notation. Transmitter-side components and receiver-side components can each be understood as error two-port and expressed as required by corresponding parameters and/or matrices.

A calibration measurement in the sense of the present invention is a measurement that serves to determine the calibration value. Accordingly, these are measurements that allow conclusions to be drawn about properties and/or the behavior of the measurement setup, so that the components of the measurement result that are attributable to the measurement setup outside the measuring zone can subsequently be compensated for with the calibration value. In particular, the calibration measurements can be used to determine a transfer function or two-port parameters, which in turn describe the behavior of the measurement setup without the measuring zone.

The calibration value can be determined by carrying out at least two, preferably at least three, calibration measurements with the measurement setup with different known properties of the measuring zone. The calibration value can then be determined using the measurement results obtained on the basis of the known properties or can be determined by this.

Calibration measurements have proven to be particularly advantageous, reproducible and accurate if they include a reflection measurement in which the measurement result is determined with a reflective measurement object of known properties positioned in the measuring zone as the first reference measurement object. Furthermore, the position of the measurement object and/or the reflection is preferably known. The first reference measurement object for reflection measurement is preferably a measurement object that at least essentially completely reflects the radar transmission signal.

Alternatively or additionally, the calibration measurements preferably have a transmission measurement in which the measurement result is determined when the measuring zone is empty or when the second reference measurement object is arranged in the measuring zone and deviates from the first reference measurement object and/or is transparent to the radar transmission signal.

The calibration value can be determined by a calibration method. A preferred example is reference measurement-based calibration methods such as SOLT (Short Open Load Through) and/or TRL (Thru Reflect Line) calibration methods.

De-embedding, i.e. the removal of influences caused by the measurement setup, can be carried out on the basis of the calibration value.

With regard to the applicable mathematics, reference is made to B. SCHIEK, “Grundlagen der Hochfrequenz-Messtechnik”, Springer-Verlag, 1999, Chapter 4, whereby the underlying mathematics described in connection with system error corrections in another context can be used to perform compensation for parts of the measurement result that are due to the measurement setup without the measuring zone.

Here, the measuring zone and/or the measurement object can be understood as a two-port whose properties are to be determined, and the measurement setup without measuring zone and/or measurement object can be described by error two-ports. On the basis of cascaded two-ports, in particular using parameters in the usual matrix notation for linear two-ports, for example using scattering parameters, transfer parameters or chain parameters and the like, one, two or more error two-port(s) can be determined as a calibration value by means of the calibration measurements and the two-port parameters of the measurement object and/or measurement setup can then be calculated as a corrected measurement result on this basis.

In addition, reference is made to Uwe Siart, “Calibration of network analyzers”, version 1.60, 22.11.2016, http://www.siart.de/lehre/nwa.pdf. The calibration procedures also disclosed here in another context can be used to determine the correction variable. The mathematics described in the literature on the calibration of network analyzers can be used with the necessary adjustments to determine the corrected measurement result, whereby the measurement setup can be described without the measuring zone and/or the measurement object as an error coefficient that represents the calibration value.

The error two-port can be described by two-port parameters such as scattering parameters, transmission parameters or chain parameters, preferably by a corresponding scattering matrix, transmission matrix or chain matrix and can be determined using mathematics known from the aforementioned sources. However, instead of performing calibration measurements with electronic calibration standards, as in the case of network analyzers, calibration measurements for the present invention are preferably performed with suitable reference measurement objects.

Thus, for a reflection measurement, an object reflecting radar transmission signals can be arranged in the measuring zone, in particular a metal plate or the like Alternatively or additionally, for the transmission measurement, a dielectric object that is permeable to the radar transmission signal in particular can be arranged as a measurement object in the measuring zone. Alternatively or additionally, a measurement can be carried out in which reflections of the radar transmission signal are prevented, for example by inserting an absorber in the measuring zone.

However, other calibration measurements are also possible as an alternative or in addition, for example using reflections at different, known positions in the measuring zone and/or measurements of transmissions of different properties, in particular different transit times, for example using objects of different thicknesses, dielectric and permeable to the radar transmission signal.

In particular, one or more of the following calibration measurements can be used as the basis for determining the calibration value:
A reflection measurement as a calibration measurement is preferably generated by a reference measurement object that is at least essentially fully reflective and correspondingly non-transmissive, i.e. preferably a mirror.
Reflection measurements can be considered as short or open measurements, in particular depending on the position of the reflection plane.
A transmission measurement, through measurement or line measurement as a calibration measurement can be carried out with an empty measuring zone or, in connection with a double transmission measurement, with a mirror in a different position to the reflector measurement, preferably outside the measuring zone and/or with the reflector at the end of the measuring zone.
An open measurement as a calibration measurement can be achieved with an absorber material as the measurement object or by diverting the radar transmission signal out of the measuring zone so that no component of the radar transmission signal is detected.
A load measurement as a calibration measurement can be carried out using a measurement object with known reflection and transmission properties in the measuring zone.
A line measurement as a calibration measurement can be achieved by using a measurement object that is permeable to the radar transmission signal and generates a delay, in particular due to a propagation speed of the radar transmission signal that differs from air.
Alternatively or additionally, one or more further calibration measurements can be carried out by arranging measurement objects with known properties at possibly different, known locations in the measuring zone. In comparison, the described reflection measurement can also be referred to as a full reflection measurement and the transmission measurement as a full transmission measurement.

Particularly preferably, a transfer function of the measurement object is determined, preferably calculated, on the basis of the radar received signals and/or with the measurement result corrected with the calibration value. It is particularly preferable that this is a complex transfer function which, in addition to magnitude information, also contains phase information and/or polarization transfer information. The (corrected) measurement result can be or be formed by the (complex) transfer function.

Determining the transfer function on the basis of the measurement result and/or as a measurement result has proven to be particularly advantageous. The transfer function, and in particular the complex transfer function, describes the properties of the measurement object in a way that is directly or indirectly particularly suitable for further analysis, correction and/or use as a model or for model building.

The transfer function and/or two-port parameters preferably correspond to the radar received signals and represent, in the sense of the present invention, a special form of representation of the measurement result.

The calibration value can also be a transfer function. This makes it possible to correct the transfer function and/or second-port parameter corresponding to the measurement result using the transfer function and/or second-port parameter representing the calibration value, thereby obtaining the corrected measurement result as a corrected transfer function or second-port parameter.

For this purpose, the (complex) transfer function and/or two-port parameter of the measurement result and the (complex) transfer function that represents/represents the calibration value can be calculated.

This makes it possible to eliminate parts of the transfer function of the entire measurement setup caused by the measurement setup and thus to select the transfer function of the measuring zone and/or the measurement object arranged therein.

Alternatively or additionally, the measurement result can be corrected by determining the overall transfer function of the measurement setup, including the measuring zone and, if applicable, the measurement object, from the measurement result and using calibration measurements to determine and eliminate the transfer function of the measurement setup without the measurement object and/or measuring zone.

A further aspect of the present invention, which can be realized independently of the compensation of parts of the measurement result which are attributable to the measurement setup without the measuring zone or the measurement object, but which can advantageously be combined with this, relates to the transformation of the measurement result or corrected measurement result and subsequent suppression of parts of the transformation result, i.e. the transformed detected or corrected measurement result. This allows a section of the transformed measurement result to be selected and/or adjacent sections to be suppressed in order to correct the measurement result. In other words, a part of the measurement result originating from a section of the measuring zone can be eliminated and/or selected. The transformation result can be filtered for this purpose.

In particular, a time or frequency curve of the measurement result is transformed into a spatial curve and a region of the spatial curve is selected by suppressing neighboring spatial regions. This makes it possible to limit the measurement result to a spatial section that contains the measurement object or a relevant part of the measurement object. Parts of the measurement result that can be traced back to irrelevant parts of the measuring zone and/or measurement object can be suppressed in this way.

In a synergistic combination of different aspects of the present invention, the measurement result can both be processed with the calibration value in order to suppress portions of the measurement result that are attributable to the measurement setup without the measuring zone and, preferably subsequently, be transformed, whereby by suppressing areas of the transformation result, portions of the measurement result, in particular portions of the measurement result that are attributable to parts or sections of the measurement object that are ultimately not intended to influence the measurement result, are suppressed.

In a production system, for example for strands and/or profiles such as pipes, it is possible to correct the measurement result and, for example, to focus on a layer, wall or similar to be monitored by masking out measurement result components of the measurement setup and of parts of the product, for example the pipe.

Optionally, the transformation result (transformed measurement result) can be back-transformed after applying a filter, such as a selection filter and/or suppression of parts. In particular, a spatial curve can be transformed back into a time or frequency-dependent curve of the measurement result, which then represents a corrected measurement result due to the suppression of unwanted components.

In other words, the time or frequency response of the measurement result is preferably transformed into a spatial response, a region of the spatial response is selected by suppressing neighboring spatial regions, and then the selected region is transformed back into a time or frequency-dependent response of the measurement result (time gating).

Thus, preferably, the phase and amplitude response of the measurement result, limited to the spatial section containing the measurement object or a relevant parts of the measurement object, can be obtained. In other words, a frequency- and/or time-dependent analysis and/or evaluation of the signal reflected and/or transmitted in this spatial section can preferably be performed. This is particularly advantageous, for example it can be used to compensate for the frequency-dependent properties of the antenna, frequency-dependent (time-of-flight) changes (e.g. frequency-dependent courses of the permittivity of materials) can be assessed and/or incorporated into the measurement, etc.

Taking the frequency-dependent phase into account, which is made possible in particular by calibration and/or time gating, preferably allows a much more precise evaluation and compensation of frequency-specific errors and artifacts. In addition, rapid changes, in particular during a pulse and/or a frequency ramp, e.g. spontaneous movements that are faster than the duration of a pulse and/or a frequency ramp, can also be inferred.

If the correction is also made by compensating for components by means of the calibration value, the measurement result is subsequently corrected twice, whereby the correction methods complement each other synergistically in that they act in different spatial areas, namely that of the measurement setup and/or the measuring zone, or are particularly effective.

A physical parameter of the measurement object is preferably determined from the (measured or corrected) measurement result or the transfer function determined from this and/or the second-port parameters determined from this. In particular, the physical parameter is a dimension of the measurement object and/or a material parameter of a material forming at least part of the measurement object.

In other words, de-embedding is preferably performed. De-embedding is the process of removing the effects of the measurement setup from data in the form of the measurement result measured in the measurement setup, in particular so that the data can be related to more useful reference planes using (vector) measurements of known standards. For example, a measurement can be de-embedded so that the reference planes are interfaces of the radar antennas, the measuring zone or the measurement object; this data can be used to create a model of the measurement object and/or measuring zone.

Alternatively or additionally, time gating is performed. Time gating isolates a part of a time data set (measurement result in the time domain and/or spatial course) for further observation and analysis. Time gating is used in particular to analyze non-stationary signals or parts of stationary signals, e.g. burst signals.

De-embedding and time-gating are preferably combined. Time gating is particularly preferred after de-embedding.

A physical parameter in the sense of the present invention is preferably a physical property of the measurement object. It is particularly preferred that this is a dimension and/or a material parameter. For example, the physical parameter may be or comprise a layer thickness and/or a material property such as a (complex) permittivity, material density, mixing ratio, absorption behaviour, polarization behaviour, roughness and/or the like.

The physical parameter can be determined by performing a comparison with a previously known reference measurement result, by performing a comparison with a previously known reference transfer function and/or by assigning the physical parameter by means of processing based on a correlation, artificial intelligence, a machine learning-based method and/or a regression method, particularly preferably a neural network. For this purpose, a dependency of the physical parameter on the measurement result and/or the transfer function can be determined or have been determined in advance and this correlation can be used as the basis for the comparison or assignment in order to derive the physical parameter on the basis of the measurement result.

Processing based on a correlation can on the one hand be a correlation in the mathematical sense, but alternatively or additionally also another assignment taking into account and/or using the property that a correlation exists. For example, it is possible to draw conclusions about the (complex) permittivity and/or layer thicknesses or dimensions from the measurement result, in particular the transfer function and/or the two-port parameters, of a measurement object, preferably taking into account knowledge about reflection and/or transmission properties of the material from which the measurement object is formed.

The (in particular corrected) measurement result or the transfer function derived therefrom and/or the physical parameter determined thereby can be used to control a positioning and/or production facility. In particular, the previously corrected measurement result or the transfer function or physical parameter determined using this can be used to determine a control value for controlling the positioning and/or production facility for the measurement object.

The positioning and/or production facility is preferably designed for the continuous or discontinuous production of a preferably strand-shaped product. The product can be located in the measuring zone and act as a measurement object. It is particularly preferred that the product moves in the measuring zone and is preferably monitored continuously in the sense of an inline measurement. In particular, the physical parameter of the product is ultimately monitored directly or indirectly. If the physical parameter deviates from a specified value, the control value can be adjusted automatically. The positioning and/or production facility is then preferably controlled or regulated on the basis of the control value.

The preferably strand-shaped product can run continuously through the measuring zone. The physical parameter or the corresponding transfer function and/or the corresponding measurement result can be determined for different positions of the product and the control value can be tracked in such a way that the physical parameter, the transfer function and/or the measurement result is/are kept constant, readjusted or controlled to a setpoint value.

A virtual model can be or can be formed of the measurement object, in particular the product, located in the measuring zone, preferably on the basis of the physical parameter, a predicted, in particular extrapolated, physical parameter, the current physical parameter and/or a previous physical parameter. The use of a virtual model for the measurement object enables particularly accurate and efficient control and/or regulation, in particular of the positioning and/or production facility.

Preferably, the virtual model, in particular as a “digital twin” of the physical properties of the modeled and the state of the model stored in a data memory, for example, is updated based on the measurement result.

The physical parameter can be derived and/or identified via a parameter for the (quality of the) agreement and/or correlation between the measurement result and the reference and/or the parameter for the quality of the (quality of the) agreement and/or correlation of the “digital twin” model and reality can be determined.

The positioning and/or production facility is preferably controlled by comparing the target value of the measurement result, the transfer function determined from it, the parameter determined from the measurement result or the transfer function and/or on the basis of the virtual model.

The positioning and/or production facility is preferably controlled or regulated on this basis or on the basis of the control value determined in this way in such a way that a predetermined or specifiable physical property of the measurement object or product is set.

If the product is an at least essentially continuously manufactured part, in particular a strand or the like, the measurement result can be determined at different locations of the measurement object or at different times, preferably continuously over different locations and/or times. In particular, it is therefore an inline measurement of the measurement result with optional evaluation by correction, determination of the transfer function and/or the physical parameter during an ongoing manufacturing process.

Here, the measurement, i.e. detection of the components, preferably takes place at different positions of the product moving in the measuring zone and forming the measurement object. This can be achieved by the product moving relative to the measurement setup. The measurement setup can therefore be part of the positioning and/or production facility and the (relative) movement can be achieved or caused by a continuous manufacturing process for a strand, in particular by an extrusion or extrusion process or the like.

A further aspect of the present invention, which can also be realized independently, relates to a system which is designed to carry out the method according to the proposal. For this purpose, the system has a radar emitter arrangement for emitting the radar transmission signal into the measuring zone of the measuring setup in which the measurement object is arranged or movable. Furthermore, the system has a radar detector arrangement for detecting both the components of the radar transmission signal transmitted by the measurement object and the components of the radar transmission signal reflected by the measurement object, which form the measurement result.

The system preferably also has an evaluation device for determining the corrected measurement result, in that the evaluation device is designed to compensate for parts of the detected measurement result that are attributable to the measurement setup without the measuring zone and/or the measurement object. Alternatively or additionally, the evaluation device is designed to correct the measurement result by transforming a time course of the detected or corrected measurement result and masking out parts of the transformed detected or corrected measurement result.

A further aspect of the present invention, which can also be realized independently, relates to the use of a—preferably FMCW- or pulse-based—radar transmission signal for determining a preferably complex transfer function comprising both magnitude information and phase information and/or polarization information of a measurement object. It is preferred that a physical property of the measurement object is inferred and/or a production plant is controlled on the basis of the transfer function.

Further advantages and features of the present invention are apparent from the claims and the following description of preferred embodiments with reference to the drawing.

It shows:

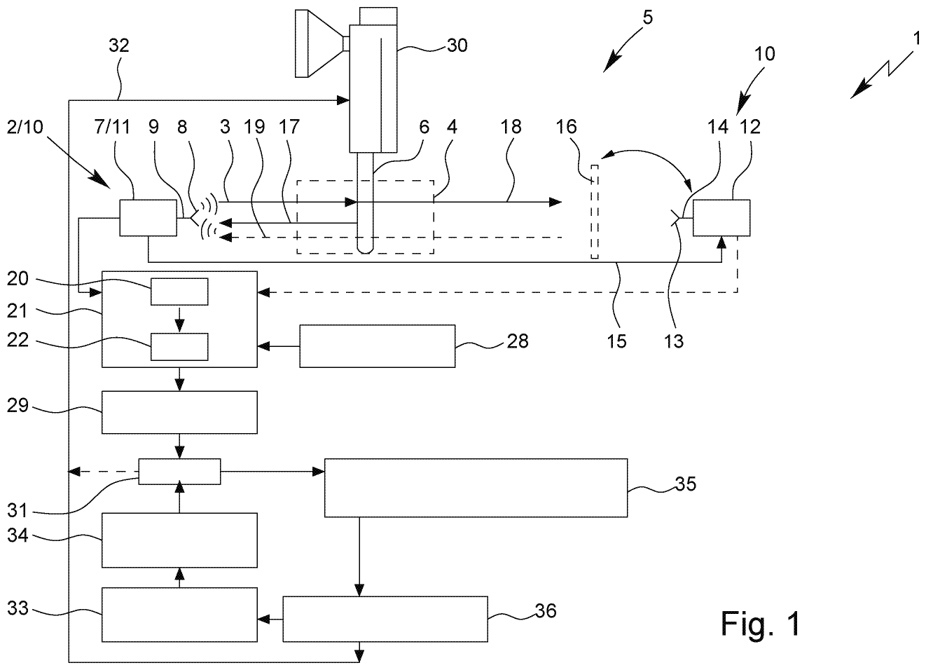

FIG. 1 a proposed system;

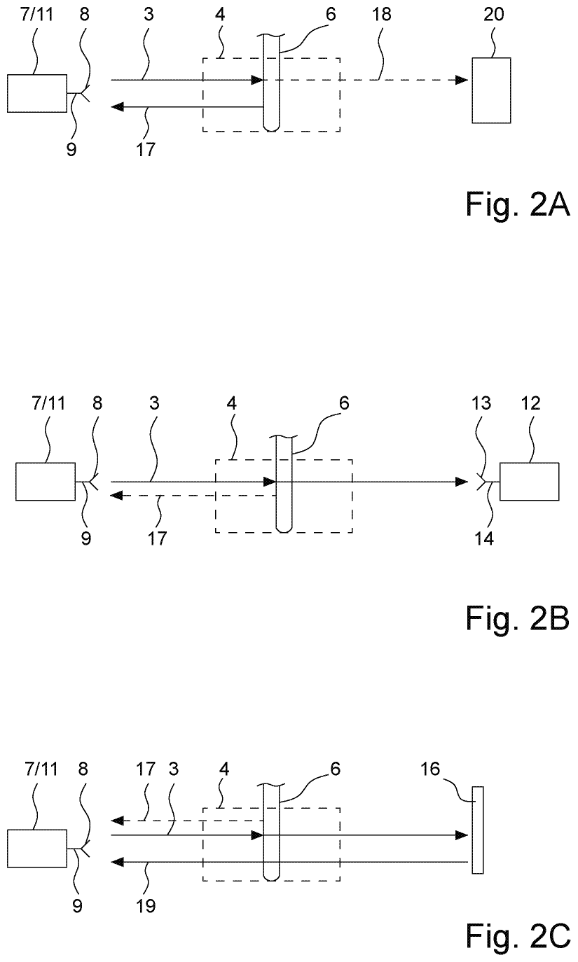

FIG. 2A a simplified schematic representation of a reflection measurement;

FIG. 2B a simplified schematic representation of a single transmission measurement;

FIG. 2C a simplified schematic representation of a double transmission measurement;

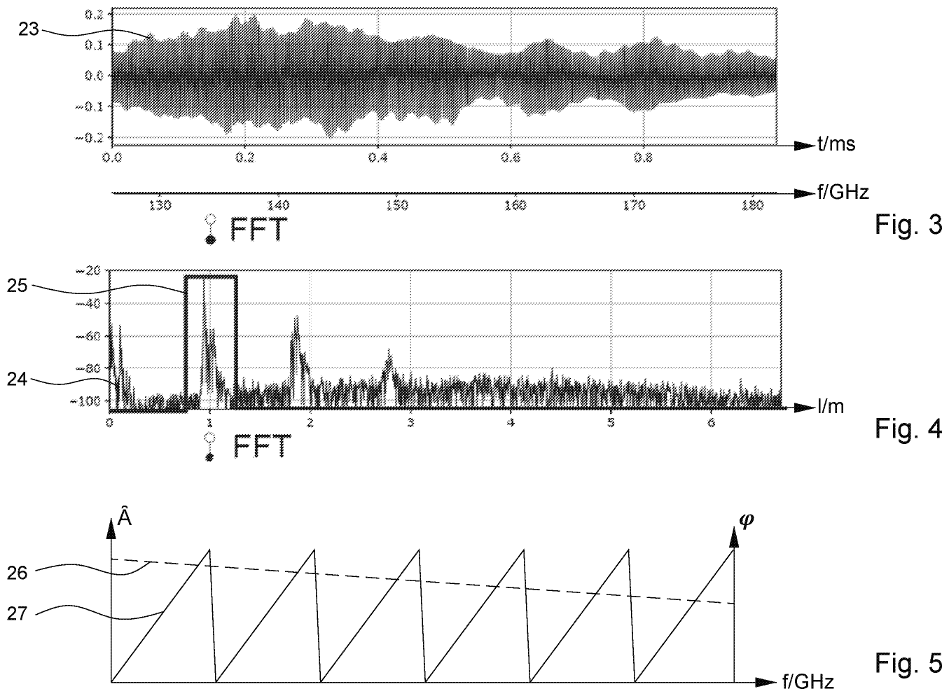

FIG. 3 a diagram showing the normalized amplitude versus time and corresponding frequency of a reflecting or transmitting component of the radar transmission signal;

FIG. 4 the transformed signal from FIG. 5 in a diagram in which the amplitude is plotted against the distance;

FIG. 5 a diagram in which the magnitude and phase of the transfer function are plotted against the frequency; and

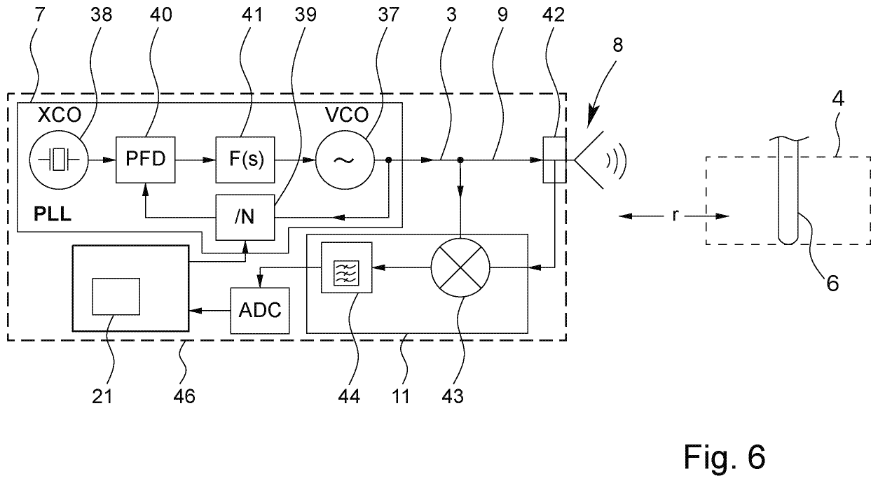

FIG. 6 a schematic block diagram of a radar transceiver comprising a radar emitter arrangement according to the proposal and a radar detector arrangement according to the proposal.

In the following, the same reference signs are used for the same or similar parts, whereby the same or similar properties and advantages can be achieved, even if repetition is refrained from in order to avoid redundancy. Furthermore, the aspects described at the beginning can be combined with the aspects explained below in connection with preferred embodiments and can be advantageous, even if this is not explicitly mentioned.

FIG. 1 shows a schematic view of a proposed system 1 for radar-based measurement. The system 1 has a radar emitter arrangement 2 for emitting a radar transmission signal 3 into a measuring zone 4 of a measurement setup 5, in which a measurement object 6 is arranged or can be arranged.

The radar emitter arrangement 2 preferably has at least one radar signal generator 7, a radar antenna 8 and a feed line 9 for coupling the radar signal generator 7 to the radar antenna 8. The radar emitter arrangement 2 is accordingly designed to conduct the radar transmission signal 3 formed by the radar signal generator 7 via the feed line 9 to the radar antenna 8, via which the radar transmission signal 3 is emitted. The radar transmission signal 3 is directed into the measuring zone 4 so that it exposes the measurement object 6 located in the measuring zone 4 to the radar radiation of the radar transmission signal 3.

The measurement object 6 can be movable or moved in the measuring zone 4. The measurement object 6 is particularly preferably a product or intermediate product whose manufacturing process can be monitored by the proposed system 1.

The system 1 according to the proposal preferably further comprises a radar detector arrangement 10. The radar detector arrangement 10 may have a radar receiver 11. This may share the radar antenna 8 and/or feed line 9 with the radar emitter arrangement 2 or have a separate radar antenna and/or feed line. In any case, the radar receiver 11 has a radar antenna 8 on the same side of the measuring zone 4 and/or measurement object 6 as the radar antenna 8 on which the radar emitter arrangement 2 emits the radar transmission signal 3.

The radar detector arrangement 10 can have a second radar receiver 12. This has a second radar antenna 13, which is coupled to the second radar receiver 12 via a second feed line 14. The second radar antenna 13 is preferably provided on a side of the measuring zone 4 and/or measurement object 6 facing away from the radar antenna 8 of the radar emitter arrangement 2. Here, it is preferred that the second radar receiver 12 is synchronized or synchronizable with the (clock of the) radar receiver(s) 11 via a synchronization connection 15. In particular, it is provided that an oscillator of the second radar receiver 12 is or can be disciplined to the clock and/or oscillations of an oscillator of the radar receiver 11. Thus, a received signal can be converted with the clock, which can correspond or correspond to the radar transmission signal 3.

In particular, local oscillator signals from mixers of the respective radar receiver 11, 12 for converting the radar reception signals are synchronized and/or can be synchronized with each other in such a way that they have the same frequency and preferably the same phase and/or a rigid phase relationship to each other.

Alternatively or in addition to the second radar receiver 12 with its second radar antenna 13 and second feed line 14, a reflector 16 may be provided. The reflector 18 preferably has a transposing effect for all or a part of the frequency range of the radar transmission signal. The reflector 16 is preferably suitable or designed to reflect the radar transmission signal 3 or parts thereof on a side of the measuring zone 4 and/or measurement object 6 facing away from the radar antenna 8 of the radar emitter arrangement 2 back towards the radar antenna 8 of the radar receiver 11 of the radar detector arrangement 10 and/or back towards the measuring zone 4 and/or measurement object 6.

In the following, reference is also made to the simplified schematic representations shown in FIGS. 2A to 2C, namely FIG. 2A with regard to the reflection of the radar transmission signal 3, FIG. 2B with regard to the transmission of the radar transmission signal 3 and FIG. 2C with regard to the double transmission of the radar transmission signal 3.

The radar transmission signal 3 is preferably partially reflected at the measurement object 6 in the measuring zone 4, resulting in a reflected component 17 of the radar transmission signal 3 that can be detected by the radar receiver 11.

A portion of the radar transmission signal 3 that penetrates the measuring zone 4 and/or the measurement object 6 either reaches the second radar antenna 13 of the second radar receiver 12 as a transmitted component 18 of the radar transmission signal 3 and is detected by it (cf. FIG. 2A) or to the reflector 16, which reflects the transmitted component 18 so that it passes through the measuring zone 4 and/or the measurement object 6 again and can ultimately be detected as a double-transmitted component 19 by the radar receiver 11 (see FIG. 2B).

If the second radar receiver 12 is provided instead of the reflector 16, the reflected component 17 and the transmitted component 18 can be detected independently of each other by the different radar receivers 11, 12. If the reflector 16 is provided instead of the second radar receiver 12, the reflected component 17 and the double-transmitted component 19 are superimposed on the radar receiver 11 (see FIG. 2C).

In order to detect the reflected component 17 and the transmitted component 18 independently of each other, the reflector 16 can therefore be controlled in such a way that the double-transmitted component 19 is enabled or suppressed. This enables conclusions to be drawn about the reflected component 17 without the proportion of the double-transmitted component 19 and thereby the optional compensation of the reflected component 17 in the received signal of the radar receiver 11 to determine the double-transmitted component 19, which corresponds or corresponds to the transmitted component 18, so that the detection of the double-transmitted component 19 as well as the transmitted component 18 also applies in the sense of the present invention.

In order to detect the reflected component 17 separately, the reflection of the transmitted component 18 can be prevented, for example by changing the direction of the reflection and/or using an absorber 47, as indicated in FIG. 2A.

With reference to FIG. 1, a measurement result 20 is or is formed which represents the reflected component 17 and transmitted component 18, 19 detected independently of one another.

The measurement result can in principle directly represent the respective component 17, 18, 19 of the radar transmission signal 3, for example by means of amplitude and phase responses of corresponding received signals or the like. However, the measurement result 20 is particularly preferably available in a processed form and/or received signals are processed accordingly, in particular with an evaluation device 21, so that the measurement result 20 continues to represent both the reflected component 17 and the transmitted component 18, 19. For this purpose, the measurement result 20 can preferably be available as a (complex) transfer function and/or two-port parameter or can be converted into this.

One way of representing the measurement result 20 as a two-port parameter, in particular a scattering parameter, is to relate the reflected component 17 as the reflected wave b₁ to the incoming wave a₁ in the form of the known radar transmission signal 3 and thereby calculate S₁₁. It is also possible to interpret the transmitted component 18, 19 as the transmitted wave b₂, to relate this to the radar transmission signal 3 and thereby determine S₂₁. The (complex) transfer function can then be calculated taking into account the reference characteristic impedances specified by the system 1 and known accordingly.

The radar transmission signal 3 preferably has frequency ramps and/or pulses and therefore preferably comprises a spectrum and/or a frequency range. This frequency range is preferably also represented as a corresponding frequency dependence in the measurement result 20. The measurement result 20 therefore preferably has a frequency dependence and/or comprises components of the different frequencies of the radar transmission signal 3, i.e. in particular a frequency-dependent transfer function and/or frequency-dependent two-port parameters such as the scattering parameters just discussed by way of example. Alternatively or additionally, the measurement result 20 has information relating to the amplitude, phase and/or polarization of the reflected component 17 and/or transmitted component 18, 19. In particular, this information can be in the form of a correspondingly complex transfer function and/or complex two-port parameters. However, other forms of representation are also possible, in particular a transfer function separated according to magnitude and phase or the like.

Preferably, a corrected measurement result 22 is determined from the measurement result 20. Two different but synergistically combinable measures are proposed for this purpose.

In one aspect of the present invention, components of the measurement result 20 attributable to the measurement setup 5 without the measuring zone 4 and/or the measurement object 6 are compensated. The resulting corrected measurement result 22 is correspondingly more accurate and reliable due to the fact that the influences of the measurement setup 5 are compensated for, whereas it is otherwise customary to minimize influences of the measurement setup 5 before or during the measurement if possible and to live with the resulting error.

Alternatively or additionally, in a further aspect of the present invention, the measurement result 20 is transformed, in particular using a Fourier transform. This is therefore a mathematical transformation of the measurement result 20, which may in particular be implemented as an FFT or DFT. Parts of the transformation result are then suppressed and/or unsuppressed parts are selected.

Preferably, a time or frequency curve of the measurement result 20 is transformed into a spatial curve and a spatial range is selected from the spatial curve by suppressing neighboring spatial ranges. In principle, the appropriately filtered transformation result can already represent the corrected measurement result 22. Preferably, however, the filtered transformation result is back-transformed so that it is available in particular as a (complex) transfer function and/or two-port parameter.

In FIG. 3, a measured time signal of a reflected or transmitted component 17, 18, 19 over time and/or frequency is shown as an example. The time signal 23 has preferably been measured on the basis of an FMCW radar transmission signal 3, in particular a frequency ramp of such a signal, by the radar detector arrangement 10. According to the ramp curve, the time axis corresponds to the frequency axis via the slope of the frequency ramp. Furthermore, a normalized amplitude of the time signal 23 is graphically represented here as an example.

The time signal 23, in particular of the reflected component 17 and/or the transmitted component 18, 19, is then transformed accordingly by a transformation, in particular Fourier transformation, into a spatial domain, as shown in FIG. 4. In this example, the transformation result 24 is plotted over a distance in meters from the radar antenna 8. Accordingly, it is easy to recognize in the transformation result 24 that portions originate from different spatial areas of the measuring zone 4 and/or distances starting from the radar antenna 8. In this context, FIG. 4 shows an example of the amplitude of the transformation result.

In order to determine the corrected measurement result 22, the transformation result 24 is preferably filtered using a filter function 25. This is preferably a filter for selecting a specific area of the transformation result 24 by masking and/or suppressing neighboring areas, in particular the transformation result 24 in other respects. After application of the filter function 25, therefore, preferably only one area of the transformation result 24 remains, around the first peak at 1 m in the example representation, while the neighboring areas are zeroed out.

Optionally, the filtered transformation result 24 can be transformed again, in particular back-transformed. FIG. 5 shows a resulting transfer function which, by masking out certain areas of the transformation result 24, ultimately represents the properties of the measuring zone 4 and/or measurement object 6 or sections thereof. By eliminating parts of the measurement result 20 that are of little or no interest for later evaluation, a corrected measurement result 22 is obtained, here exemplified in the form of the transfer function.

FIG. 5 shows the amplitude 26 on the one hand and the phase 27 of the resulting transfer function over the frequency on the other. The sawtooth shape of the curve describing the phase 27 results from the fact that the curve continues at 0° when a phase of 360° is reached, which corresponds to 0°.

In FIG. 5, the existing variations of the magnitude/amplitude 26 and phase 27 are shown almost linearly. However, in practice, preferably and/or depending on the measurement object 6, deviating curves with more significant fluctuations and/or non-linear curves of magnitude/amplitude 26, phase 27 and/or polarization are possible.

Preferably, for at least one, preferably both or each, component(s) 17, 18 and/or each receiver 11, 12, the amplitude 26, phase 27, polarization and/or amplitude 26 and/or phase 27 per polarization plane (as a curve over the frequency of the radar transmission signal 3 for different frequencies) are detected and represented by the measurement result 22. Furthermore, the aforementioned measurement results of the components 17, 18 are preferably also evaluated, corrected and/or used in the following.

The combination of the two methods for correcting the measurement result 20 is also particularly advantageous due to the fact that the compensation of components of the measurement result 20 that are attributable to the measurement setup 5 enables the elimination of errors outside the measuring zone 4, while the transformation and subsequent filtering enables the measurement result 20 to be restricted to a section of the measuring zone 4, i.e. to suppress disturbances or errors occurring in the measuring zone 4. It is precisely the combination of these measures that leads to a particularly accurate, meaningful, corrected measurement result 22.

The compensation of components of the measurement result 20 that are attributable to the measurement setup 5 without the measuring zone 4 and/or the measurement object 6 can be performed by means of a calibration value 28. For this purpose, the measurement result 20 can be processed with the calibration value 28 in order to compensate for the components of the measurement result 20 that are caused by the measurement setup 5 outside the measuring zone 4.

Preferably, the calibration value 28 represents a transfer function, two-port parameter or corresponding information of the measurement setup 5 without the measuring zone 4. The calibration value 28 is preferably in a form that corresponds to the form of the measurement result 20 and/or enables a correction of the measurement result 20 by offsetting, for example as a transfer function or (scatter) matrix.

The calibration value 28 can describe influences caused by the radar emitter arrangement 2 and the radar detector arrangement 10. Disturbance variables caused, for example, by the radar signal generator 7, the radar antenna 8 and/or the feed line 9 on the transmitter side and in the area of the radar receiver 11 and optionally in the area of the second radar receiver 12, the second radar antenna 13 and the second feed line 14 are therefore preferably reflected in the calibration value 28, so that processing of the measurement result 20 with the calibration value 28 leads to the compensation described. The compensation does not have to be complete, but can also be a partly compensation of corresponding components, especially since parasitic effects and uncertainties in the calibration value 28 always mean that a compensation can never be completely complete. Preferably, however, it is predominantly.

Calibration measurements are preferably carried out with the system 1 to determine the calibration value 28. For this purpose, measurement results 20 are determined under different known conditions, i.e. properties of the measuring zone 4.

For example, the measuring zone 4 can be empty, have an absorber 47 or a deflection for the radar transmission signal 3, so that both the reflected component 17 and the transmitted component 18, 19 are eliminated and the measurement result 20 only represents effects of the measurement setup 5 without the measuring zone 4.

Alternatively or additionally, at least one reflection measurement is performed, in which a reflector at a predetermined or known position in the measuring zone 4 at least substantially reflects the radar transmission signal 3 so that it reaches the radar receiver 11 at least approximately completely.

A further calibration measurement can be carried out in the form of a transmission measurement, which in the case where the second radar receiver 12 with its feed line 14 and antenna 13 is provided, can simply be carried out when the measuring zone 4 is empty. If the double-transmitted component 19 is measured by the radar receiver 11, the transmission measurement can be carried out with the reflector 16.

Alternatively or additionally, one or more calibration measurements can be carried out with reference measurement objects 6 in the measuring zone 4, of which the reflection and transmission properties are known. In particular, transit time changes due to a change in position of a reflector 16 used in the measuring zone 4 or the reflector 16 provided for the double transmission measurement can be provided and/or used for calibration measurements and/or a dielectric measurement object 6 of known properties shortens or extends the transit time for electromagnetic waves in the measuring zone 4 to a known extent.

The calibration measurements can then be used to determine the calibration value 28.

In particular, the calibration value 28 can be determined on the basis of two-port parameters by eliminating certain of the reflected component 17, the transmitted component 18 and/or the double-transmitted component 19 or by bringing them to a previously known value or a previously known ratio using a suitable reference measurement object 6 and, on the basis of the previously known information, conclusions can then be drawn about the properties of the measurement setup 5, which are described by the calibration value 28.

The calibration value 28 may, for example, be two-port parameters, in particular scattering, transmission and/or chain parameters. For example, the calibration value 28 can have a two-port matrix such as a scatter matrix or chain matrix for the radar emitter arrangement 2 and the radar detector arrangement 10, and the errors described by the calibration value 28 can then be eliminated from the measurement result 20, which is also present in a two-port matrix, in particular a scatter matrix or chain matrix, by means of corresponding matrix operations.

The correction of the measurement result 20 and/or formation of the corrected measurement result 22 can be carried out by the evaluation device 21 using the calibration value 28, as indicated in FIG. 1.

In a further aspect of the present invention, a physical parameter 29 is determined on the basis of the measurement result 20, particularly preferably on the basis of the corrected measurement result 22. This is particularly preferably a geometric or material parameter of the measurement object 6, for example a material property such as a permittivity and/or a geometric property such as a layer thickness or wall thickness.

The physical parameter 29 can be determined in that the preferably corrected measurement result 20, 22 is compared or examined taking into account a correlation with a previously known reference or a known physical relationship and the physical parameter 29 is thereby determined or assigned on the basis of the, preferably corrected, measurement result 20, 22.

This can be done by comparison with a previously known reference measurement result for which a physical parameter is known. Alternatively or additionally, the measurement result 20, 22 can be processed on the basis of a correlation, using artificial intelligence (AI), for example a machine learning-based method, using a neural network, by applying a regression method or the like.

A further aspect of the present invention relates to the control or regulation of a positioning and/or production facility 30 on the basis of the measurement result 20, 22, preferably using the physical parameter 29. For this purpose, the measurement result 20, 22 or the physical parameter 29 can be used to determine a control value 32, in particular by means of a comparison device 31, with which the positioning and/or production facility 30 can be controlled.

In the illustration example according to FIG. 1, the positioning and/or production facility 30 is shown as an extruder for extruding a product as measurement object 6. However, the positioning and/or production facility 30 can also be another industrial facility in which a product is manufactured and/or positioned.

With the system 1 according to the proposal, the product as measurement object 6 is preferably monitored with respect to the physical parameter 29 and the control value 32 is automatically determined or predicted such that the positioning and/or production facility 30 is set or can be set with the control value 32 so that the physical parameter 29 corresponds to a setpoint value. In the case of a positioning system 30, a position may be predetermined and the physical parameter 29 may represent a position, while the physical parameter 29 is particularly preferably a material property and/or dimension of the measurement object 6 or corresponds thereto.

In a further aspect of the present invention, which can also be realized independently, the control value 32 is determined by the measurement result 20, 22, preferably by determining the physical parameter 29, by means of a virtual model 33 of the measurement object 6.

The virtual model 33 can, for example, represent materials and/or geometries of the measurement object 6. The virtual model 33 can be used as a basis for determining the control value 32 in that the virtual model 33 is generated or adapted with the measurement result 20, 22 and/or physical parameter 29 so that it represents the measurement object 6. Alternatively or additionally, a virtual model 33 of a given measurement object 6 and/or product can be used to generate a comparison value for determining the control value 32. In particular, the virtual model 33 can be used to determine, calculate, in particular simulate a setpoint value, in particular a setpoint value for the physical parameter 29 and/or the measurement result 20, 22.

The virtual model 33 can be modeled as an analytical model with the physical parameters 29 as input variables and the measurement result 20, in particular in the form of the preferably complex transfer function, as output variable.

Alternatively or additionally, the virtual model 33 can be generated by simulation by simulating a modeled physical parameter and/or a modeled measurement result or model parameter 34 corresponding thereto, wherein the model parameter 34 preferably corresponds to the physical parameter 29 or the measurement result 20, 22.

The virtual model 33 may fully or partially represent the measurement object 6. In this case, in which the virtual model 33 represents the measurement object 6, preferably on the basis of the measurement result 20, 22 and/or physical parameter 29, the control value 32 can be determined by means of the virtual model 33 by comparing the properties of the virtual model 33, such as a layer thickness, wall thickness or another physical parameter 29 of the virtual model 33, in particular with a setpoint value.

In a specific example, the control value 32 is determined by comparing the measurement result 20, 22 in the form of a transfer function with a known or calculated transfer function of an object or virtual model 33 whose physical properties are known and can be assigned accordingly by the comparison.

The virtual model 33 can be compared by comparison with the measurement result 20, 22 and/or the physical parameter 29, in particular by means of the comparison device 31. The result of this comparison can be used by an adaptation device 35 to (dynamically) adapt the virtual model 33 so that it corresponds to the measurement object 6.

In turn, the control value 32 for controlling the positioning and/or production facility 30 can be derived from the (adapted) virtual model 33. For this purpose, for example, a physical or other model parameter 34 derived from the virtual model 33 can be compared by the comparison device 31 with the physical parameter 29 determined from the measurement result 20, 22 and the control value 32 can be determined on this basis. This is then preferably used to control the positioning and/or production facility 30.

Alternatively or additionally, the control value 32 can be derived directly from the virtual model 33. This can be done, in particular, after adaptation of the virtual model 33 by means of the adaptation device 35 by a control device 36.

Based on the virtual model 33, the control device 36 can derive the control value 32, which in turn is used to control and/or regulate the positioning and/or production facility 30.

The positioning and/or production facility 30 is preferably controlled and/or regulated by the control value 28 in such a way that a predetermined or specifiable physical property 29 of the product acting as measurement object 6 is set.

For this purpose, the system 1 can be used to perform a so-called inline measurement, i.e. to determine the measurement result 20, 22 and/or the physical parameter 29, the virtual model 33 adapted on this basis and/or the control value 32 derived from this from a measurement object 6, which represents a product in the ongoing manufacturing process.

For example, the positioning and/or production facility 30 designed as an extrusion system in FIG. 1 can be monitored by means of the system 1 according to the proposal, in that the physical parameter 29 of the product acting as measurement object 6 is determined repeatedly or continuously and, on the basis of the measurement result 20, 22 determined from this, the positioning and/or production facility 30, in this case the extrusion system, can be controlled in such a way that the physical parameter 29 is set as desired, for example a specific, predetermined pipe and/or profile geometry.

As a result, the present invention allows the positioning and/or production facility 30 to be controlled. In this case, the measurement object 6 is examined by means of measurement radiation in the form of the radar transmission signal 3 in the GHz or THz range by a scanning radar sensor comprising the radar emitter arrangement 2 and the radar detector arrangement 10.

The reflected component 17 and/or the transmitted component 18, 19 of the radar transmission signal 3 are detected, with the detection preferably taking place at different locations of the measurement object 6 and/or at different times.

It is also preferable that the parts of the reflected component 17 and transmitted component 18, 19 and/or quantities determined from these are separated, which are attributable to the measurement object 6.

Taking into account the result or comparing the result with reference data, a physical property of the measurement object 6 can be inferred and the positioning and/or production facility 30 can be controlled, in particular regulated, on the basis of this.

Alternatively or additionally, production quality can be assessed or ensured. The control of the positioning and/or production facility 30 is therefore not necessarily provided for, since quality assurance can in any case be carried out alternatively on the basis of the process aspects explained above.

In principle, it is also possible to control and/or regulate a positioning function of the positioning and/or production facility 30. For this purpose, a position, attitude, orientation or the like of the measurement object 6 can be determined from the measurement result 20, 22 and approximated to a target value by reducing the distance.

In addition to layer thickness measurement, the present invention is also suitable for monitoring flow velocities and/or for (complex) permittivity measurement in the radar beam for flow measurement.

FIG. 6 shows a schematic block diagram with the radar signal generator 7 and the radar receiver 11.

The radar signal generator 7 preferably has an oscillator 37. The oscillator 37 can be stabilized via a phase-locked loop by means of a reference oscillator 38. The phase-locked loop has a divider 39, which divides the output signal of the oscillator 37, in this case the radar transmission signal 3, and forwards it to a phase-frequency discriminator 40, which compares the divided radar transmission signal 3 with the reference signal of the reference oscillator 38. An oscillator control value generated by the phase-frequency discriminator 40 is filtered by a loop filter and used to control the oscillator 37. The oscillator 37 is a voltage-controlled oscillator in the present case, but can in principle also be an oscillator controlled in another way.

The radar transmission signal 3 is preferably routed to the radar antenna 8 via the feed line 9 and radiated into the measuring zone 4 via this.

The measurement object 6 can be located at a distance r in the measuring zone 4, which reflects parts of the radar transmission signal 3 and thus forms the reflected component 17, which in turn is received again by the radar antenna 8 in the present embodiment and fed to the radar receiver 11. However, the radar receiver 11 may also receive other components of the radar transmission signal 3 and/or have a separate antenna/feed line.

If, as in the example shown, the radar receiver 11 divides the antenna 8 with the radar transmission signal 3, a directional coupler 42 can decouple the radar transmission signal 3 received by the radar antenna 8 and route it to the radar receiver 11.

The radar receiver 11 preferably has a mixer 43 which, particularly preferably with the radar transmission signal 3 as a local oscillator signal, mixes the radar reception signal. It can then optionally be filtered by a filter 44 and/or further processed into a digital signal by an analog-to-digital converter 45.

Further processing can be carried out by a control device 46, which can have the evaluation device 21 or be coupled to it. Alternatively or additionally, the radar signal generator 7 can be controlled by the control device 46 in order to generate the radar transmission signal 3. In particular, the control device 46 controls the divider 39 so that the oscillator 37 generates frequency ramps or pulses as FMCW or pulse radar signal as a result.

Different aspects of the present invention may also be realized and advantageous individually or in different combinations.

### LIST OF REFERENCE SYMBOLS

1 System
2 Radar emitter arrangement
3 Radar transmission signal
4 Measuring zone
5 Measurement setup
6 Measurement object
7 Radar signal generator
8 First radar antenna
9 First feed line
10 Radar detector arrangement
11 First radar receiver
12 Second radar receiver
13 Second radar antenna
14 Second feed line
15 Synchronization connection
16 Reflector
17 Reflected component
18 Transmitted component
19 Double-transmitted component
20 Measurement result
21 Evaluation device
22 Corrected measurement result
23 Time signal
24 Transformation result
25 Filter function
26 Amplitude of the transfer function
27 Phase of the transfer function
28 Calibration value
29 Physical parameter
30 Positioning and/or production facility
31 Comparison device
32 Control value
33 Virtual model
34 Model parameter
35 Adaptation device
36 Control device
37 Oscillator
38 Reference oscillator
39 Divider
40 PFD
41 Loop filter
42 Directional coupler
43 Mixer
44 Filter
45 ADC
46 Control device
47 Absorber
R Distance

1-15. (canceled)

16. A method for radar-based measurement, the method comprising:
emission of a radar transmission signal into a measuring zone of a measurement setup in which the measurement object can be arranged or is arranged, and
detection independently of one another of both at least one component of the radar transmission signal reflected by the measurement object and at least one component of the radar transmission signal transmitted by the measurement object referred to as radar received signals, and forming a measurement result representing the radar received signals.

17. The method according to claim 16, wherein the radar transmission signal is FMCW- or pulse-based.

18. The method according to claim 16, wherein a corrected measurement result is determined from the measurement result by compensating for components of the measurement result which are attributable to the measurement setup without the measuring zone.

19. The method according to claim 18, wherein the measurement result is processed with a calibration value in order to compensate for the components of the measurement result which are caused by the measurement setup outside the measuring zone.

20. The method according to claim 19, wherein the calibration value is or is determined in that at least two or three calibration measurements are carried out with the measurement setup with different, respectively known properties of the measuring zone and the calibration value is or is determined with the measurement results obtained on the basis of the known properties.

21. The method according to claim 19, wherein the calibration value represents a transfer function or two-port parameter of the measurement setup without the measuring zone.

22. The method according to claim 16, wherein a corrected measurement result is determined from the measurement result by transforming or Fourier transforming the measurement result and subsequently suppressing parts of the transformation result.

23. The method according to claim 22, wherein a time or frequency characteristic of the measurement result is transformed into a spatial characteristic and a spatial region is selected from the spatial characteristic by suppressing neighboring spatial regions.

24. The method according to claim 23, wherein the calibration measurements at least one of:
(a) having a reflection measurement, in which the measurement result is determined with a reference measurement object of known properties arranged in the measuring zone being a at least partially reflective reference measurement object, and
(b) having a transmission measurement in which the measurement result is determined with an empty measuring zone or with a second reference measurement object which is arranged in the measuring zone that differs from the first reference measurement object and is at least partially transparent to the radar transmission signal.

25. The method according to claim 16, wherein the measurement result is a transfer function or two-port parameter of the measurement object or these are determined or calculated from the radar received signals.

26. The method according to claim 25, wherein the transfer function is a complex transfer function or two-port parameter comprising both magnitude transfer information and phase transfer information or polarization transfer information.

27. The method according to claim 16, wherein a physical parameter, a dimension or a material parameter of the measurement object is determined from the measurement result.

28. The method according to claim 27, wherein the physical parameter is determined in that the physical parameter is determined or assigned by one or more of a comparison with a previously known reference measurement result, by processing on the basis of a correlation, by processing on the basis an artificial intelligence, by processing on the basis a machine learning-based method, by processing on the basis a neural network, or by processing on the basis a regression method.

29. The method according to claim 16, wherein one or more of the corrected measurement result, the transfer function, the two-port parameters, or the determined physical parameter is used to determine a control value for controlling a positioning or production facility for the measurement object.

30. The method according to claim 29, wherein the positioning or production facility for the continuous or discontinuous production of a product, which acts as a measurement object moving in the measuring zone is controlled or feedback controlled on the basis of the control value.

31. The method according to claim 29, wherein a virtual model is or is formed of the measurement object located in the measuring zone.

32. The method according to claim 31, wherein the virtual model is formed on the basis of one or more of the current, previous, predicted, or extrapolated physical parameter.

33. The method according to claim 32, wherein the virtual model is verified on the basis of a degree of correlation of the virtual model with the measurement result or the physical parameter

34. The method according to claim 32, wherein the control value is or is derived from the virtual model.

35. The method according to claim 29, wherein the positioning or production facility is controlled with a target value comparison of one or more of the measurement result, the transfer function, the two-port parameters, or of the physical parameter of the measurement object.

36. The method according to claim 29, wherein the positioning or production facility is controlled or feedback controlled on the basis of the measurement result, or the physical parameter.

37. The method according to claim 29, wherein the control value is determined on the basis of the measurement result or the physical parameter in such a way that a predetermined or predeterminable physical property of the product acting as measurement object is set.

38. The method according to claim 16, wherein the measurement result is determined one or more of at different locations of the measurement object, at different times, or continuously over different locations or over time.

39. The method according to claim 16, wherein the measurement object is a continuously manufactured product and the measurement results obtained by inline measurement during the ongoing manufacturing process of the product acting as the measurement object at different positions of the product moving in the measuring zone and forming the measurement object.

40. A system for radar-based measurement comprising:
a radar emitter arrangement for emitting a radar transmission signal into a measuring zone of a measuring setup in which a measurement object is arranged or can be arranged, and
a radar detector arrangement for detecting both components transmitted from the measurement object and components of the radar transmission signal reflected from the measurement object, and for forming a measurement result representing both the transmitted component and the reflected component of the radar transmission signal, and
an evaluation device for correcting the measurement result by one or more of:
compensating for components of the detected measurement result which are attributable to the measurement setup without the measuring zone; or
transforming a time course of the measurement result and hiding parts of the transformation result.

41. A method of determining a complex transfer function or complex two-port parameters, comprising both magnitude transfer information and phase transfer information of a measurement object by means of a radar transmission signal.

42. The method of claim 41, wherein a physical property of the measurement object is inferred on the basis of the transfer function or the two-port parameters.
